(19) United States
(12) Patent Application Publication
(10) Pub. No.: US 2007/0260856 A1
(43) Pub. Date: Nov. 8, 2007

(54) Methods and apparatus to detect data dependencies in an instruction pipeline

(76) Inventors: Thang Minh Tran, Austin, TX (US); Paul Kenneth Miller, Dripping Springs, TX (US); James Nolan Hardage JR., Dripping Springs, TX (US)

Correspondence Address: TEXAS INSTRUMENTS INCORPORATED, P O BOX 655474, M/S 3999, DALLAS, TX, 75265, US

(21) Appl. No.: 11/418,650

(22) Filed: May 5, 2006

(51) Int. Cl. G06F 9/30

(52) U.S. Cl. 712/217

(57) ABSTRACT

Example methods and apparatus to detect data dependencies in an instruction pipeline are disclosed. A disclosed example method uses an address pointer associated with a first instruction and indicates a first data dependency status of the first instruction. The example method then indicates a second data dependency status of the second instruction based on an instruction type of the first instruction and an instruction type of a second instruction.

### FIELD OF THE DISCLOSURE

The present disclosure relates generally to processor systems and, more particularly, to methods, and apparatus to detect data dependencies in an instruction pipeline.

### BACKGROUND

Processors such as RISC (Reduced Instruction Set Computing) processors, digital signal processing (DSP) chips, and/or other integrated circuit devices play an important role in many systems and applications such as mobile wireless communication systems and applications. Reducing the cost of manufacture, increasing the efficiency of executing more instructions per cycle, and addressing power dissipation without compromising performance are important goals in processor, DSP, integrated circuit, and system-on-a-chip (SOC) designs. These goals are particularly significant in hand held/mobile applications where small size is desired.

To execute instructions, microprocessors are provided with instruction pipelines and circuitry to regulate the flow of instructions in the instruction pipelines. Some instruction pipeline stages or units, (often referred to as instruction decode stages or instruction dispatch units), monitor the instructions which are already executing (i.e., active or issued instructions) and determine whether to issue pending instructions for execution. This process is called instruction dispatch or instruction issue. If the instruction decode stage determines that a pending instruction depends on a result value of an active instruction (e.g., a data dependency or data hazard) that has not yet completed execution, the instruction decode stage stalls the pending instruction until completion of the active instruction on which the pending instruction is dependant. Stalling pending instructions reduces processor performance.

Software programmers and/or software compilers often sequence instructions in an order that reduces data dependencies between substantially adjacent instructions in an attempt to increase frequency of instruction issuance. However, despite such efforts, data dependencies or data hazards still occur requiring instruction decode stages to stall pending instructions.

Approaches to improving processor performance typically involve adding more pipeline stages (i.e., increase pipeline depth or length) and increasing the clock frequency and/or by adding more instruction pipelines and arithmetic functional units to enable issuing two or more instructions per clock cycle. Consequently, the complexity of configuring instruction pipelines and associated circuitry to regulate the instruction issuance process in an efficient manner has increased.

### BRIEF DESCRIPTION OF THE DRAWINGS

FIG. 1 depicts an example instruction pipeline and a scoreboard communicatively coupled thereto.

FIG. 2. depicts another example instruction pipeline having example primary and secondary scoreboards coupled thereto.

FIG. 3 depicts a detailed illustration of the example secondary scoreboard of FIG. 2.

FIG. 4 depicts a timing diagram representative of information signals associated with implementing the example secondary scoreboard of FIGS. 2 and 3 to detect data dependencies in an instruction pipeline.

FIGS. 5A and 5B depict a flowchart of an example method illustrating how information signals are communicated in the secondary scoreboard of FIGS. 2 and 3 to detect data dependencies.

FIG. 6 depicts a flowchart of an example method illustrating how data dependency information may be retrieved from the secondary scoreboard of FIGS. 2 and 3.

FIG. 7 is an example wireless communication devices in which the example methods and apparatus described herein may be implemented.

### DETAILED DESCRIPTION

The example methods and apparatus described herein may be used to detect data dependencies in an instruction pipeline. In an example implementation, a processor (such as a microprocessor) is provided with first and second scoreboards to detect read-after-write (“RAW”) data hazards associated with pipeline processing and to enable parallel processing of different instruction types. A first scoreboard may be implemented using a known scoreboard configuration to detect data hazards between pending instructions. The second scoreboard may be implemented as described below to detect the instruction types (e.g., integer instruction type, floating-point instruction type, etc.) of pending instruction and to implement issue and forwarding control of the pipeline based on the detected instruction types to enable parallel execution of different instruction types (e.g., integer and floating-point instructions) when no RAW data hazards are detected.

The term ‘instruction type’ is used herein to distinguish between instructions that use a first type of data or data type (i.e., first data type instructions) and instructions that use a second data type (i.e., second data type instructions). In other example implementations, ‘instruction type’ may be used to distinguish between instructions that perform different operations (e.g., multiply, multiply-accumulate, shift, subtract, etc.). Example implementations are described herein using integer instruction types (i.e., integer data type instructions) and floating-point instruction types (i.e., floating-point data type instructions). Integer instruction types use integer data type operands and produce integer data type results. Floating-point instruction types use floating-point data type operands and produce floating-point data type results. Example integer data types used by digital signal processors (“DSP's”) include 16-bit signed/unsigned short integer format and 32-bit signed/unsigned single-precision integer format. Example floating-point data types used by DSP's include short floating-point format, single-precision floating-point format, and extended-precision floating-point format. Although the example methods and apparatus are described herein using integer and floating-point instruction types, in alternative example implementations, the example methods and apparatus may be implemented using additional or alternative instruction types. For example, the example methods and apparatus may be implemented to work with and differentiate between different floating-point type instructions (e.g., floating-point multiply-accumulate (“MAC”) instruction, floating-point multiply (“MUL”) instruction, etc.) and different integer type instructions (e.g., integer MAC instruction, integer MUL instruction, etc.).

An example pipeline has a plurality of pipeline stages, each of which performs a different function to process an instruction. A typical pipeline includes: an instruction fetch stage to fetch instructions to be processed; an instruction decode stage to decode an instruction, read operands, and issue instructions; an execution stage to execute operations indicated by the instructions; and a write-back stage to write results back to a register file. The quantity of stages in a pipeline may increase by separating operations performed in one stage into two or more stages. For example, an execution stage may be separated into two or more stages that form different functional units to execute relatively more complex instructions using relatively more stages or functional units. Some pipelines include integer data type functional units (i.e., integer functional units) and floating-point data type functional units (i.e., floating-point functional units) to execute both integer instruction types and floating-point instruction types.

Instruction pipelines may be implemented using various configurations. For example, in-order pipelines enable issuance of instructions in a sequential manner. An in-order pipeline issues a plurality of sequentially fetched instructions in the same sequence or order in which they were fetched. If a pending instruction depends on the result of an active or issued instruction (e.g., an ‘in-flight’ instruction being executed in the execution stage of a pipeline), a data dependency or a data hazard exists because the result of the active instruction is used as the operand of the pending instruction. In this case, the instruction decode stage stalls the pending instruction from issuing into the execution stage until the active instruction produces its result to thereby clear the data dependency. When the in-order pipeline stalls the pending instruction, it also stalls any subsequent instructions regardless of their data dependency status. After the data dependency is cleared, the in-order pipeline issues the pending instruction. In in-order pipelines, instructions having many data dependencies result in frequent pipeline stalling, which, in turn, results in reduced processor performance.

To determine whether data dependencies exist, pipelines are often provided with scoreboards. Scoreboards are used to detect data hazards (e.g., read after write (“RAW”) hazards) by tracking operand data and result data of pending and active instructions. For example, if the scoreboard determines that the source operand(s) of a pending instruction depend on the result(s) of an active instruction, the scoreboard will indicate a RAW data hazard and cause the pending instruction to stall until the data dependency is cleared (e.g., until the result(s) of the active instruction become available).

Result values may be produced at different functional units of execution pipeline stages depending on the complexity of the operations associated with instructions. Thus, due to the quantity of stages in a pipeline, even though a relatively simple instruction may require one or two functional units in the execution stage to complete, it typically requires several instruction cycles to propagate the result of such an active instruction through the remaining functional units and pipeline stages to write that result back to a result register from where a pending instruction can access the result for use as an operand. To increase instruction execution performance by reducing the amount of time between the production of a result and the availability of the result to a pending instruction, many pipelines are provided with data forwarding paths. Data forwarding paths are implemented between arithmetic functional units of execution pipeline stages at which result values may be produced and earlier arithmetic functional units of pipeline stages at which source operand values are read. Consequently, the result need not propagate through the remainder of the pipeline before becoming available to a pending instruction. For example, in a seven-stage pipeline, a result value produced at pipeline stage five may be forwarded back to a read operand stage (e.g., pipeline stage two) via a data forwarding path. In this manner, the read operand stage does not have to wait for the result value to be propagated through the sixth and seventh stages to be stored in a corresponding result register (i.e., the source operand register for the pending instruction) to enable the read operand stage to retrieve the result value (e.g., the source operand value for the pending instruction). The quantity of data forwarding paths implemented to service an instruction pipeline is typically based on analysis of the increased performance of adding any additional forwarding path versus the cost of adding the forwarding path.

To further increase instruction execution performance of instruction pipelines, execution stages of instruction pipelines may be implemented using two or more parallel execution stages (i.e., parallel execution pipelines). Each parallel execution pipeline can be used to process particular data type instructions. For example, some parallel execution pipelines can be implemented to execute integer instruction types, and other parallel execution pipelines can be implemented to execute floating-point instruction types.

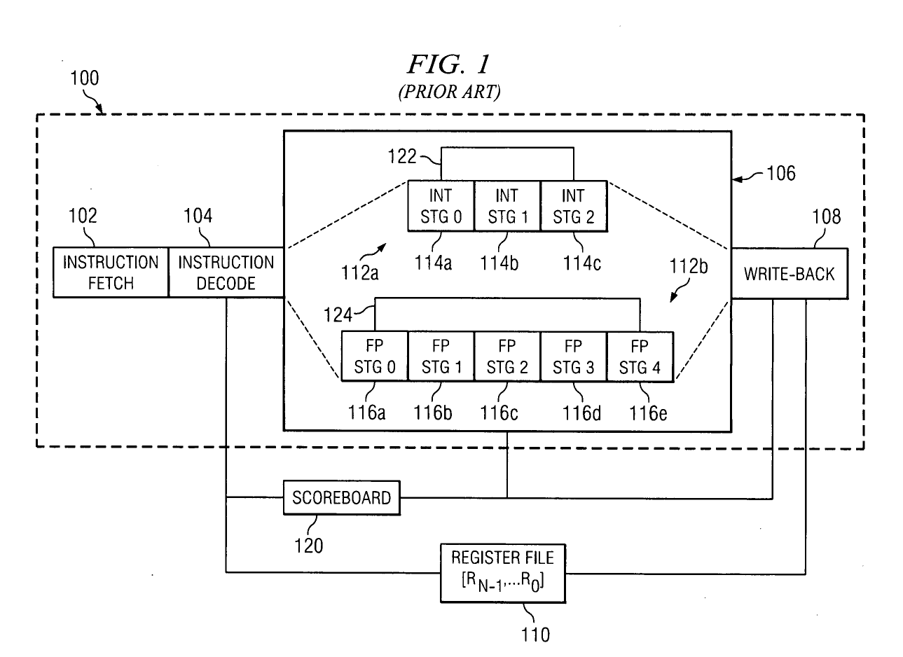

Turning to FIG. 1, an illustrated example instruction pipeline 100 includes an instruction fetch stage 102, an instruction decode stage 104, an execution stage 106, and a write-back stage 108. The instruction fetch stage 102 fetches instructions from a memory (not shown). The instruction decode stage 104 decodes the fetched instructions to determine their associated op-codes (e.g., their associated operations) and registers for source operand values and result values. The instruction decode stage 104 is communicatively coupled to a register file 110 having a plurality of (N) [R_{N-1}, . . . , R₀] registers (e.g., N-32 registers) used to store the source operand and result values. In this manner, the instruction decode stage 104 can fetch source operand values for instructions from the register file 110. The instruction decode stage 104 also issues pending instructions into the execution stage 106 if no data dependencies exist for those pending instructions.

The example instruction pipeline 100 of FIG. 1 enables different instruction types (e.g., integer and floating-point instruction types) to be processed in parallel, thus increasing instruction execution performance. In particular, the execution stage 106 includes an integer execution pipeline 112a in parallel with a floating-point execution pipeline 112b. The integer execution pipeline 112a includes integer execution stages 114a-c to execute integer instruction types and the floating-point execution pipeline 112b includes floating-point execution stages 116a-e to execute floating-point instruction types. The integer execution stages 114a-c may form one or more integer functional units (not shown) and the floating-point execution stages 116a-e may form one or more floating-point functional units (not shown). For example, an integer arithmetic logic unit (“ALU”) may be implemented using one integer execution stage (e.g., one of the integer execution stages 114a-c) and a floating-point multiply-accumulate (“MAC”) functional unit may be implemented using five floating-point execution stages (e.g., the floating-point execution stages 116a-e).

Although three integer execution stages 114a-c and five floating-point execution stages 116a-c are shown, the execution stage 106 may have any number of integer and floating-point execution stages. In an example implementation, the integer execution pipeline 112a may include an integer MAC functional unit (which may be implemented using three integer execution stages), an integer ALU functional unit (which may be implemented using one integer execution stage), and a shifter functional unit (which may be implemented using one integer execution stage). In addition, the floating-point execution pipeline 112b may include a floating-point multiply (“MUL”) functional unit (which may be implemented using five floating-point execution stages), a floating-point MAC functional unit (which may be implemented using five floating-point execution stages), and a floating-point ALU functional unit (which may be implemented using three floating-point execution stages).

A scoreboard 120, implemented according to known scoreboard configurations, is provided to detect register data dependencies between active instructions and pending instructions to determine whether the instruction decode stage 104 should issue pending instructions. For example, if the scoreboard 120 determines that the source operands of a pending floating-point instruction in the instruction decode stage 104 are not dependant (i.e., no data dependency or data hazard) on a result of any active instruction in the parallel execution pipelines 112a-b, then the instruction decode stage 104 issues the pending floating-point instruction to the floating-point execution pipeline 112b. The floating-point execution pipeline 112b then executes the floating-point instruction while the integer execution pipeline 112a executes integer instructions. On the other hand, if the scoreboard 120 detects a data dependency between the pending instruction and an active instruction, the instruction decode stage 104 stalls the pending instruction until a result on which the pending instruction depends is produced, stored in the register file 110 (for subsequent access by the pending instruction), and the data dependency is cleared.

In an example implementation, the scoreboard 120 may detect two types of RAW data dependencies or RAW hazards. A first type of RAW hazard occurs when a result is not valid (e.g., not yet produced), and thus the result is not yet available for forwarding or for retrieval as a source operand. A second type of RAW hazard occurs when the result has been produced and is available for forwarding, but the instruction depending on the result is in a different execution pipeline from the execution pipeline in which the result is produced and no data forwarding paths exist between the separate execution pipelines. For example, if a floating-point instruction is dependent on an integer result, the floating-point execution pipeline 112b must be stalled until the integer result produced in the integer execution pipeline 112a is propagated through the integer execution pipeline 112a and written back to the register file 110 for subsequent retrieval by the pending floating-point instruction.

As shown in FIG. 1, each of the parallel execution pipelines 112a-b includes a respective data forwarding path 122 and 124 (i.e., intra-pipeline data forwarding paths 122 and 124). The data forwarding paths 122 and 124 are used to enable early availability of instruction results to pending instructions without requiring the instruction results to propagate through the remainder of the pipeline 100 before the pending instruction can access the result. However, the data forwarding paths 122 and 124 can only forward results within the same execution pipeline (i.e., intra-pipeline data forwarding). That is, a floating-point result produced in one of the execution stages 116a-e of the floating-point execution pipeline 112b can only be forwarded to another one of the execution stages 116a-e within the floating-point execution pipeline 112b. Without further modification, if a pending integer instruction depends on a result of a floating-point instruction, the pending integer instruction must wait until the floating-point instruction result propagates through the floating-point execution pipeline 112b and is written to a register file 110 by the write-back stage 108. Similarly, without further modification, if a pending floating-point instruction depends on a result of an integer instruction, the pending floating-point instruction must wait until the integer instruction result propagates through the integer execution pipeline 112a and is written to a register file 110 by the write-back stage 108.

To enable data forwarding between the parallel execution pipelines 112a-b (i.e., inter-pipeline data forwarding), additional data forwarding paths (not shown) may be implemented between the execution pipelines 112a-b. Although data forwarding paths between the execution pipelines 112a-b (i.e., inter-pipeline data forwarding paths) increase instruction execution performance, the costs and die space required to add inter-pipeline data forwarding paths between the execution pipelines 112a-b can be substantial. To maintain relatively low system costs and die space requirements associated with data forwarding paths, data forwarding paths between parallel execution pipelines are omitted. Instruction execution performance is then dependent on the ability of software programmers and/or software compilers to organize the order of instructions to reduce or eliminate data dependencies. However, such instruction ordering is not perfect and data dependencies will still occur.

Although the instruction pipeline 100 of FIG. 1 is shown as having the execution pipelines 112a-b in a parallel configuration, the instruction pipeline 100 may alternatively be implemented to have one execution pipeline having the different data type functional units (e.g., the integer execution stages 114a-c and the floating-point execution stages 116a-e) intermingled in a serial configuration. In this case data forwarding paths may be formed between functional units of the same data type (i.e., intra-data-type functional unit forwarding paths). However, to reduce die space and cost, data forwarding paths between functional units of different data types (i.e., inter-data-type functional unit forwarding paths) may not be implemented. The example methods and apparatus described herein may be implemented and/or used in connection with the parallel execution pipelines 112a-b and/or with serial pipelines having different data type functional units (e.g., the integer execution stages 114a-c and the floating-point execution stages 116a-e) in a serial configuration.

Although the scoreboard 120 is capable of determining whether register data dependencies exist, the scoreboard 120 is unable to determine the instruction types with which the data dependencies are associated. Accordingly, the example instruction pipeline 100 allows only one type of instruction in the execution stage 106. If there is an active integer instruction in the execution stage 106, all subsequently retrieved floating-point instructions are stalled until the execution stage 106 finishes processing the active integer instruction.

The example methods and apparatus described herein may be used to achieve relatively higher instruction execution performance without implementing data forwarding paths between the execution pipelines 112a-b (or between functional units of different data types) by determining whether data dependencies exist between different data type instructions (e.g., inter-pipeline data dependencies or inter-data-type data dependencies) and issuing the different data type instructions to be executed in parallel when no data dependencies exist between the different data type instructions.

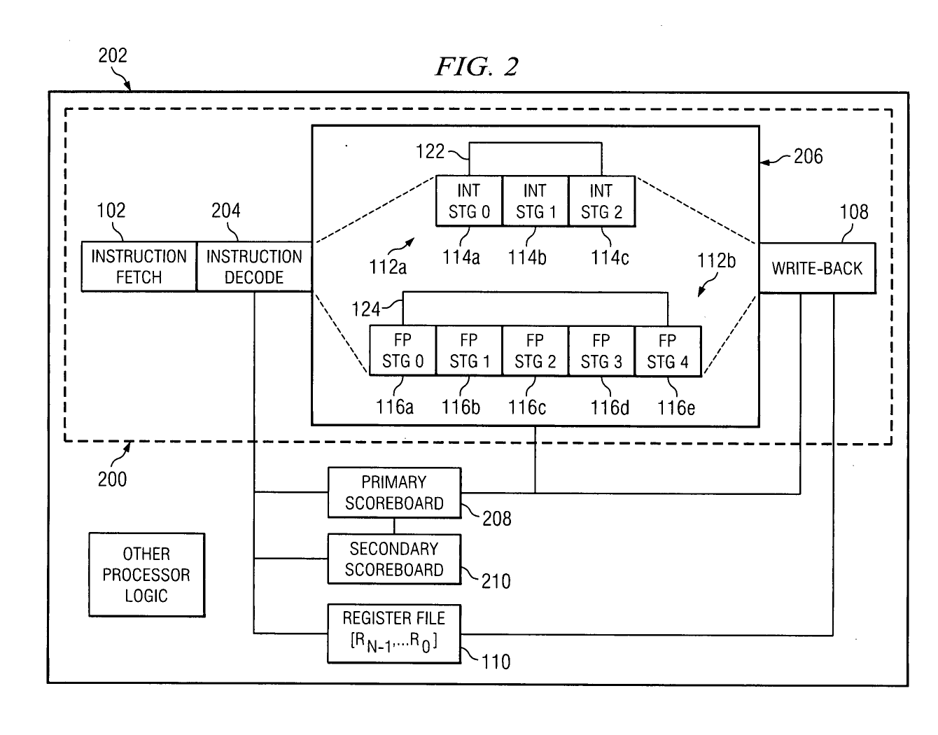

To this end, an example instruction pipeline 200 of FIG. 2, which may be used to implement a processor core (not shown) of a processor 202, is provided with an example primary scoreboard 208 and an example secondary scoreboard 210. The primary scoreboard 208 enables detecting register data dependencies as described above and is substantially similar or identical to the scoreboard 120 of FIG. 1. The secondary scoreboard 210 is configured to detect RAW data hazards between different instruction types (e.g., integer instruction types and floating-point instruction types) and to allow an instruction decode stage 204 to issue the different instruction types to be executed in parallel in an execution stage 206 when no RAW data hazards exist between the different instruction types (e.g., no inter-data-type dependencies exist).

The secondary scoreboard 210 is communicatively coupled to the primary scoreboard 208 and the instruction decode stage 204. The secondary scoreboard 210 receives data dependency information from the primary scoreboard 208 and communicates RAW dependency information associated with different instruction types to the instruction decode stage 204. The secondary scoreboard 210 receives source operand register and result register information from the instruction decode stage 204 to determine RAW data dependencies between instructions based on the instructions' uses of registers within the register file 110.

The instruction pipeline 200 employs some of the same structures as the instruction pipeline 100. In the interest of brevity, these same or similar structures are not re-described here. Instead, the interested reader is referred to the description of FIG. 1 for a complete description of those structures. To facilitate the process, like structures have like reference numerals in FIGS. 1 and 2.

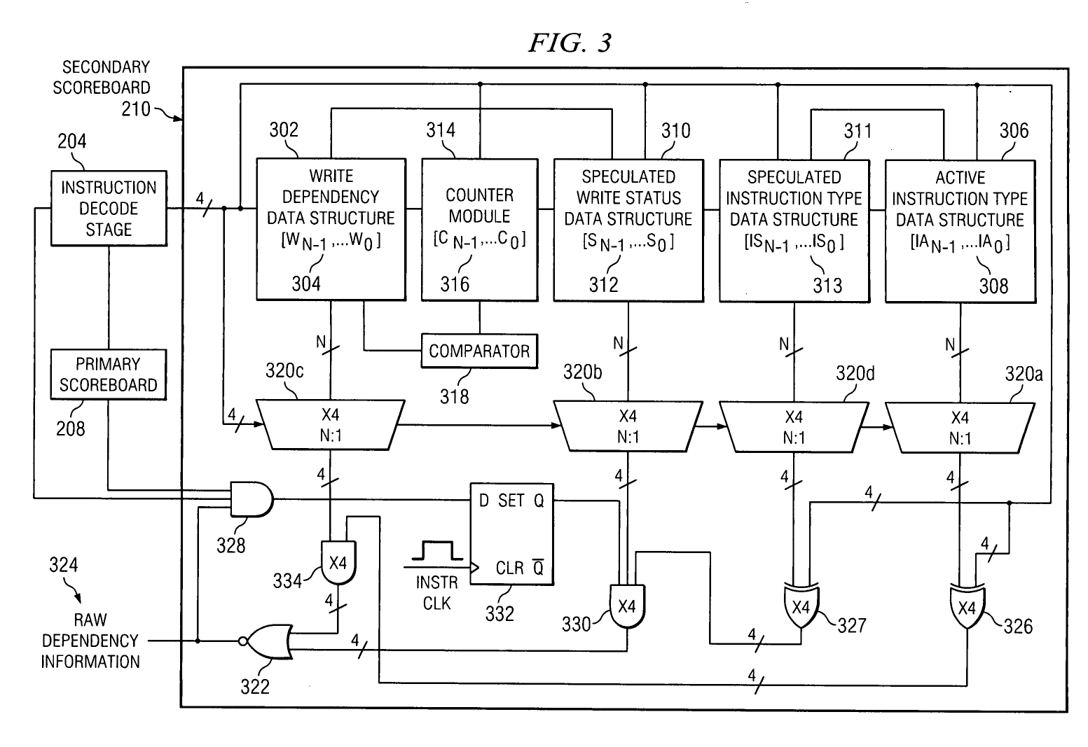

FIG. 3 is a detailed illustration of the example secondary scoreboard 210 of FIG. 2. The instruction decode stage 204 decodes pending instructions and communicates to the example secondary scoreboard 210 register address pointers associated with source operand registers (e.g., read address pointers) and result registers (e.g., write address pointers), instruction type information (e.g., integer instruction type and floating-point instruction type), information indicative of whether an issued instruction will write to the register file (e.g., the register file 110 of FIG. 2), and instruction conflicts (e.g., functional unit conflicts, memory conflicts, etc.) detected by the instruction decode stage 204.

To store information indicative of whether an active instruction will write data into the register file 110 (FIG. 2), the secondary scoreboard 210 includes a write dependency data structure 302. In the illustrated example, the write dependency data structure 302 includes a plurality of write dependency status bits [W_{N-1}, . . . , W₀] 304. Each of the write dependency status bits [W_{N-1}, . . . , W₀] 304 pertains to a respective one of the registers R_{N-1}-R₀ of the register file 110 and indicates whether its respective one of the registers R_{N-1}-R₀ awaits an active instruction (in one of the execution stages of the pipelines 112a-b) to store a result value therein. For example, a bit value equal to zero in one of the write dependency status bits [W_{N-1}, . . . , W₀] 304 may be used to indicate that a pending write does not exist for the corresponding register and a bit value equal to one stored in one of the write dependency status bits [W_{N-1}, . . . , W₀] 304 may be used to indicate a pending write exists for the corresponding register. In an example implementation having N=32 registers (i.e., R₃₁-R₀), the write dependency data structure 302 includes thirty-two write dependency status bits [W_{N-1}, . . . , W₀] 304. In this case, a first write dependency status bit W₀ corresponds to a first register R₀, a second write dependency status bit W₁ corresponds to a second register R₁, etc.

To store instruction type information for an active instruction, the secondary scoreboard 210 includes an active instruction type data structure 306. The active instruction type data structure 306 may be used to store information indicative of the type of the instructions (e.g., integer instruction type or floating-point instruction type) that will write result values to corresponding ones of the registers R_{N-1}-R₀ in the register file 110. In the illustrated example, the active instruction type data structure 306 includes a plurality of active instruction type status bits [IA_{N-1}, . . . , IA₀] 308, each of which corresponds to a respective one of the registers R_{N-1}-R₀ of the register file 110. In the illustrated example, a bit value equal to zero is indicative of an integer instruction type and a bit value equal to one is indicative of a floating-point instruction type. The active instruction type data structure 306 obtains the instruction type information from the instruction decode stage 204.

In an alternative example implementation, to differentiate between three or more instruction types (e.g., a floating-point MAC instruction, a floating-point MUL instruction, an integer MAC instruction, an integer MUL instruction, etc.), the active instruction type data structure 306 may be provided with two status bits (e.g., the active instruction type status bits [IA_{N-1}, . . . , IA₀] 308) for each one of the registers R_{N-1}-R₀. In this manner, for each of the registers R_{N-1}-R₀, two status bits may be used to identify an instruction type selected from a group of four instruction types.

The secondary scoreboard 210 is provided with a speculated write data structure 310 to store information indicative of whether it is speculated that an instruction that will write a result to the register file 110 has issued into one of the parallel instruction stage pipelines 112a-b (FIGS. 1 and 2). In the illustrated example, the speculated write data structure 310 includes a plurality of speculated status bits [S_{N-1}, . . . , S₀] 312, each of which corresponds to a respective one of the registers R_{N-1}-R₀ of the register file 110. During operation, the instruction decode stage 204 decodes a pending instruction and communicates result operand register address pointer(s) (e.g., the register address pointer(s) of one(s) of the registers R_{N-1}-R₀ of the register file 110) to the speculated write data structure 310 indicating that it has decoded a pending instruction that will write a result to particular one(s) of the registers R_{N-1}-R₀ of the register file 110. Because the instruction decode stage 204 may or may not issue the pending instruction in the same instruction cycle (e.g., the second half of the instruction cycle), the information (e.g., bit values) stored in the speculated write data structure 310 indicates only that it is speculated that the pending instruction was issued. Whether the instruction decode stage 204 actually issued the instruction in the same cycle may depend on conditions in the primary scoreboard 208 or other conditions (e.g., functional unit conflicts, memory conflicts, etc.) detected by, for example, the instruction decode stage 204 and cannot be determined until the next or subsequent instruction cycle. Thus, when the instruction decode stage 204 decodes an instruction that will write a result to one of the registers R_{N-1}-R₀ of the register file 110, the speculated write data structure 310 sets a corresponding one of the speculated status bits [S_{N-1}, . . . , S₀] 312 to indicate that the instruction may or may not have been issued.

To store instruction type information for a speculated instruction, the secondary scoreboard 210 includes a speculated instruction type data structure 311. The speculated instruction type data structure 311 may be used to store information indicative of the instruction types of the speculated instructions for which a speculated bit is stored in the speculated write data structure 310. In the illustrated example, the speculated instruction type data structure 311 includes a plurality of speculated instruction type status bits [IS_{N-1}, . . . , IS₀] 313, each of which corresponds to a respective one of the registers R_{N-1}-R₀ of the register file 110. In the illustrated example, a bit value equal to zero is indicative of an integer instruction type and a bit value equal to one is indicative of a floating-point instruction type. The speculated instruction type data structure 311 obtains the instruction type information from the instruction decode stage 204.

In an alternative example implementation, to differentiate between three or more instruction types (e.g., a floating-point MAC instruction, a floating-point MUL instruction, an integer MAC instruction, an integer MUL instruction, etc.), the speculated instruction type data structure 311 may be provided with two status bits (e.g., the speculated instruction type status bits [IS_{N-1}, . . . , IS₀] 313) for each one of the registers R_{N-1}-R₀.

To determine when an issued instruction (i.e., an active instruction) will produce a result, the secondary scoreboard 210 is provided with an execution stage counter module 314. The counter module 314 includes a plurality of counters [C_{N-1}, . . . , C₀] 316, each of which corresponds to a respective one of the registers R_{N-1}-R₀ of the register file 110. The counter module 314 indicates the number of stages (e.g., the execution stages 114a-c and 116a-e of FIG. 2) in one of the execution pipelines 112a or 112b remaining before an active instruction produces its result. In the illustrated example, each of the plurality of counters [C_{N-1}, . . . , C₀] 316 is a 3-bit counter to accommodate a maximum stage count (i.e., a maximum functional unit count) of five (e.g., the five floating-point execution stages 116a-e of the floating-point execution pipeline 112b). Although the counter module 314 is described as having a plurality of counters [C_{N-1}, . . . , C₀] 316, the counter module 314 may alternatively be implemented using a plurality of shift registers [SR_{N-1}, . . . , SR₀] (not shown). Each of the shift registers [SR_{N-1}, . . . , SR₀] would correspond to a particular register R_{N-1}-R₀ to count the number of execution stages remaining before an active instruction produces its result to be stored in that register. If the counter module 314 is implemented using the shift registers [SR_{N-1}, . . . , SR₀], each of the write dependency status bits [W_{N-1}, . . . , W₀] 304 may be implemented using the most significant bit of a respective one of the shift registers [SR_{N-1}, . . . , SR₀] (e.g., the most significant bit of the shift register SR₀ is used to implement the write dependency status bit W₀). In this manner, when a bit in a shift register SR is shifted to the most significant bit position, the corresponding write dependency status bit W is set to one.

During operation, when the instruction decode stage 204 decodes an integer instruction that requires all three of the integer execution stages 114a-c, the instruction decode stage 204 communicates a value of three and the register address pointer of the one of the registers R_{N-1}-R₀ to which the integer instruction will write a result to the counter module 314. The counter module 314 responds by setting a value of three in the respective one of the counters [C_{N-1}, . . . , C₀] 316 designated by the register address pointer. When the instruction decode stage 204 issues the integer instruction, the counter [C_{N-1}, . . . , C₀] 316 corresponding to the designated register decrements once per instruction cycle until reaching zero indicating that the integer instruction has produced its result.

To determine when the counters [C_{N-1}, . . . , C₀] 316 decrement to zero, the secondary scoreboard 210 is provided with a comparator 318 that compares the counter values to zero. In an example implementation, the comparator 318 may be implemented using a three-input logic OR gate (e.g., one gate input per counter bit) that indicates a zero count value when the logic OR gate output is low (i.e., a zero output). When one of the counters [C_{N-1}, . . . , C₀] 316 has decremented to zero, the comparator 318 causes the write dependency data structure 302 to clear a corresponding one of the write dependency bits [W_{N-1}, . . . , W₀] 304 in the write dependency data structure 302 to indicate that the data dependency is cleared because the active instruction has written its result back to the register file 110 (FIG. 2). If the counter module 314 is implemented using the shift registers [SR_{N-1}, . . . , SR₀], then the comparator 318 need not be provided because the write dependency bits [W_{N-1}, . . . , W₀] 304 are automatically set when bits in the shift register are shifted to the most significant bit positions as described above.

To determine whether RAW dependencies exist for the registers R_{N-1}-R₀ of the register file 110 based on the write dependency data structure 302, the active instruction type data structure 306, and the speculated write data structure 310, the secondary scoreboard 210 is provided with a plurality of (N:1) multiplexers 320a-d (i.e., the active instruction type multiplexer 320a, the speculated write multiplexer 320b, the write dependency multiplexer 320c, and the speculated instruction type multiplexer 320d). The instruction type multiplexer 320a has N inputs corresponding to the active instruction type status bits [IA_{N-1}, . . . , IA₀] 308, the speculated write multiplexer 320b has N inputs corresponding to the speculated status bits [S_{N-1}, . . . , S₀] 312, the write dependency multiplexer 320c has N inputs corresponding to the write dependency bits [W_{N-1}, . . . , W₀] 304, and the speculated instruction type multiplexer 320d has N inputs corresponding to the speculated instruction type status bits [IS_{N-1}, . . . , IS₀] 313.

In the illustrated example, the instruction decode stage 204 can decode an instruction that can use up to four source operands. To check for RAW data dependencies for four of the registers R_{N-1}-R₀ to be used for the four source operands, the secondary scoreboard 210 is provided with four (×4) active instruction type multiplexers 320a, four (×4) speculated write multiplexers 320b, four (×4) write dependency multiplexers 320c, and four (×4) speculated instruction type multiplexers 320d. In alternative example implementations, the instruction decode stage 204 may be configured to decode two or more instructions simultaneously and additional or expanded logic (e.g., the multiplexers 320a-d described above and logic gates described below) may be provided to process the two or more simultaneously decoded instructions.

For each decoded instruction, the instruction decode stage 204 communicates register address pointers for the registers R_{N-1}-R₀ from which the decoded instruction will read its source operands. The multiplexers 320a-d then retrieve the bit values corresponding to the register address pointers from the active instruction type data structure 306, the speculated write data structure 310, the write dependency data structure 302, and the speculated instruction type data structure 311. The bit values output by the multiplexers 320a-d are then propagated through a plurality of logic gates to determine whether a RAW data dependency exists for the pending instruction based on the register address pointers provided to the secondary scoreboard 210.

As shown in FIG. 3, the secondary scoreboard 210 is provided with a logic NOR gate 322 to output a RAW data dependency information logic signal 324 to indicate whether a RAW data dependency exists for the pending instruction. In the illustrated example, to output the RAW data dependency logic signal 324, the NOR gate 322 has eight inputs. A first four inputs of the NOR gate 322 receive data dependency information (e.g., logic signals) for four source registers of a pending instruction based on data dependency information corresponding to an active instruction (e.g., based on information stored in the write dependency data structure 302 and the active instruction type data structure 306). The other four inputs of the NOR gate 322 represent data dependencies for the four source registers based on data dependency information corresponding to a speculated instruction (e.g., based on information stored in the speculated write status data structure 310 and the speculated instruction type data structure 311) and other factors described below (e.g., factors provided by the instruction decode stage 204 and the primary scoreboard 208) that may indicate that an instruction should not be issued. For example, if a pending instruction in the instruction decode stage 204 is configured to use registers R₇-R₄ for its source operands, the instruction decode stage 204 provides the register address pointers for the registers R₇-R₄ and the secondary scoreboard 210 provides the RAW data dependency logic signal 324 via the logic NOR gate 322 to indicate whether a RAW data dependency exists for any one or more of the registers R₇-R₄. That is, if a RAW data dependency exists for at least one of the registers R₇-R₄, the RAW data dependency logic signal 324 will indicate that a RAW data dependency exists for the pending instruction.

To determine whether an active instruction in the execution stage 106 and a pending instruction in the instruction decode stage 204 are of the same instruction type, the secondary scoreboard 210 is provided with a logic exclusive-OR gate 326. In the illustrated example, the secondary scoreboard 210 is provided with four (×4) logic exclusive-OR gates 326. However, for purposes of clarity, the secondary scoreboard 210 is described with respect to one of the exclusive-OR gates 326. A first input of the exclusive-OR gate 326 is connected to the output of the active instruction type multiplexer 320a. The active instruction type multiplexer 320a provides an active instruction type bit value indicative of the instruction type of an active instruction that will write a result value to a respective one of the registers R_{N-1}-R₀ (e.g., write a result to R₅). The instruction decode stage 204 provides a pending instruction type bit value to the second input of the exclusive-OR gate 326 indicative of an instruction type of a pending instruction in the instruction decode stage 204 intended to write a result value to a respective one of the registers R_{N-1}-R₀ (e.g., write a result to R₅). If the active and pending instruction type bit values provided to the inputs of the exclusive-OR gate 326 are different, then the exclusive-OR gate 326 outputs information (e.g., a high logic signal “1”) indicating that the active instruction and the pending instruction, both of which intend to write to the same one of the registers R_{N-1}-R₀ (e.g., write to R₅), are different instruction types (e.g., the active instruction is an integer instruction and the pending instruction is a floating-point instruction).

To determine whether a speculated instruction (e.g., an instruction that may have issued to the execution stage 106 or may still be pending in the instruction decode stage 204) and a pending instruction in the instruction decode stage 204 are of the same instruction type, the secondary scoreboard 210 is provided with a logic exclusive-OR gate 327. In the illustrated example, the secondary scoreboard 210 is provided with four (×4) logic exclusive-OR gates 327. However, for purposes of clarity, the secondary scoreboard 210 is described with respect to one of the exclusive-OR gates 327. A first input of the exclusive-OR gate 327 is connected to the output of the speculated instruction type multiplexer 320d. The speculated instruction type multiplexer 320d provides a speculated instruction type bit value indicative of the instruction type of a speculated instruction that will write a result value to a respective one of the registers R_{N-1}-R₀ (e.g., write a result to R₅). The instruction decode stage 204 provides a pending instruction type bit value to the second input of the exclusive-OR gate 327 indicative of an instruction type of a pending instruction in the instruction decode stage 204 intended to write a result value to a respective one of the registers R_{N-1}-R₀ (e.g., write a result to R₅). If the speculated and pending instruction type bit values provided to the inputs of the exclusive-OR gate 327 are different, then the exclusive-OR gate 327 outputs information (e.g., a high logic signal “1”) indicating that the speculated instruction and the pending instruction, both of which intend to write to the same one of the registers R_{N-1}-R₀ (e.g., write to R₅), are different instruction types (e.g., the speculated instruction is an integer instruction and the pending instruction is a floating-point instruction).

To determine whether factors, other than the secondary scoreboard 210, indicate that a pending instruction should not be issued, the secondary scoreboard is provided with a logic AND gate 328. Other factors that may indicate that an instruction should not be issued include data dependencies detected by the primary scoreboard 208 or instruction conflicts (e.g., instructions require use of the same functional unit in the execution stage 106, memory conflicts, etc.) detected by the instruction decode stage 204. As shown in FIG. 3, a first input of the AND gate 328 is connected to the primary scoreboard 208, a second input of the AND gate 328 is connected to the instruction decode stage 204, and a third input of the AND gate 328 is connected to the output of the NOR gate 322 to receive the RAW dependency information logic signal 324.

To determine whether definite or speculated data dependencies exist for the registers R_{N-1}-R₀, the secondary scoreboard 210 is provided with a logic AND gate 330. Although in the illustrated example the secondary scoreboard 210 is provided with four (×4) logic AND gates 330, for purposes of clarity, the secondary scoreboard 210 is described with respect to one of the AND gates 330. A first input of the AND gate 330 is connected to the output of the speculated write multiplexer 320b. The speculated write multiplexer 320b provides a speculated write status bit value indicative of whether it is speculated that an instruction, which may or may not have been issued, will write a result value to one of the registers R_{N-1}-R₀ (e.g., write to R₅). A second input of the AND gate 330 is connected to the output of the XOR gate 327 described above. A third input of the AND gate 330 is connected to the output of the AND gate 328 via a D-type flip-flop 332. In the illustrated example, the output of the D-type flip-flop 332 connects to the third input of each of the four AND gates 330. The D-type flip-flop 332 is provided to stabilize the RAW data dependency information logic signal 324 output of the NOR gate 322 so that a loop formed by the NOR gate 322 and the AND gates 328 and 330 will not cause the output of the NOR gate 322 to oscillate. The output of the AND gate 330 will indicate whether any definite or speculated data dependencies exist based on the speculated write status data structure 310, the speculated instruction type data structure 311, the instruction decode stage 204, the primary scoreboard 208, and the RAW dependency information logic signal 324.

The RAW dependency information logic signal 324 output by the NOR gate 322 is based on the logic signal outputs of the AND gates 330 and the logic signal outputs of AND gates 334 (four (×4) AND gates 334 are provided). In particular, a first four inputs of the NOR gate 322 are connected to the output of a respective AND gate 334 and a second four inputs of the NOR gate 322 are connected to outputs of a respective AND gate 330. Each AND gate 334 outputs a logic signal indicating whether a data dependency is detected in the write dependency data structure 302 or whether a corresponding XOR gate 326 indicates that the instruction types of active and pending instructions are different.

In the illustrated example, the counter module 314 is used to indicate whether data forwarding is required for a pending instruction. In particular, a count value in the counter module 314 corresponding to the active integer instruction will indicate that data forwarding is required if the count value is not equal to zero. For example, if a pending integer instruction in the instruction decode stage 204 depends on an active integer instruction in an execution stage of the integer pipeline 112a (FIG. 2), the primary scoreboard 208 may indicate that a data dependency exists between the pending integer instruction and the active integer instruction, but the RAW dependency information logic signal 324 may indicate that no RAW data dependency exists between the integer pipeline and the floating-point pipeline (e.g., no inter-pipeline or inter-data-type data dependency exists) because the pending and active instructions are of the same instruction types—an integer instruction type. Thus, the secondary scoreboard 210 will enable the instruction decode stage 204 to issue the pending integer instruction.

In contrast, if the pending instruction in the instruction decode stage 204 is dependant on an active instruction and the pending and active instructions are of different instruction types (e.g., an inter-pipeline or inter-data-type dependency exists between a pending floating-point instruction and an active integer instruction), then the secondary scoreboard 210 will not allow the instruction decode stage 204 to issue the pending instruction regardless of a count value in the counter module 314 corresponding to the active instruction. The pending instruction cannot be issued because no data forwarding paths exist between the integer and floating-point execution pipelines 112a-b, and thus the result of the active instruction cannot be forwarded from one of the execution pipelines 112a-b to another one of the execution pipelines 112a-b for the pending instruction. Instead, the secondary scoreboard 210 will not allow the instruction decode stage 204 to issue the pending instruction until one of the counters [C_{N-1}, . . . , C₀] 316 in the counter module 314 corresponding to the active instruction has decremented to zero and the write dependency data structure 302 clears one of the write dependency status bits [W_{N-1}, . . . , W₀] 304 corresponding to the active instruction in response to the corresponding counter [C_{N-1}, . . . , C₀] 316 decrementing to zero.

Although the primary and secondary scoreboards 208 and 210 are described above as separate scoreboards, in alternative example implementations the primary and secondary scoreboards 208 and 210 may be implemented as one scoreboard to detect data dependencies and allow the instruction decode stage 204 to issue instructions of different types as described above.

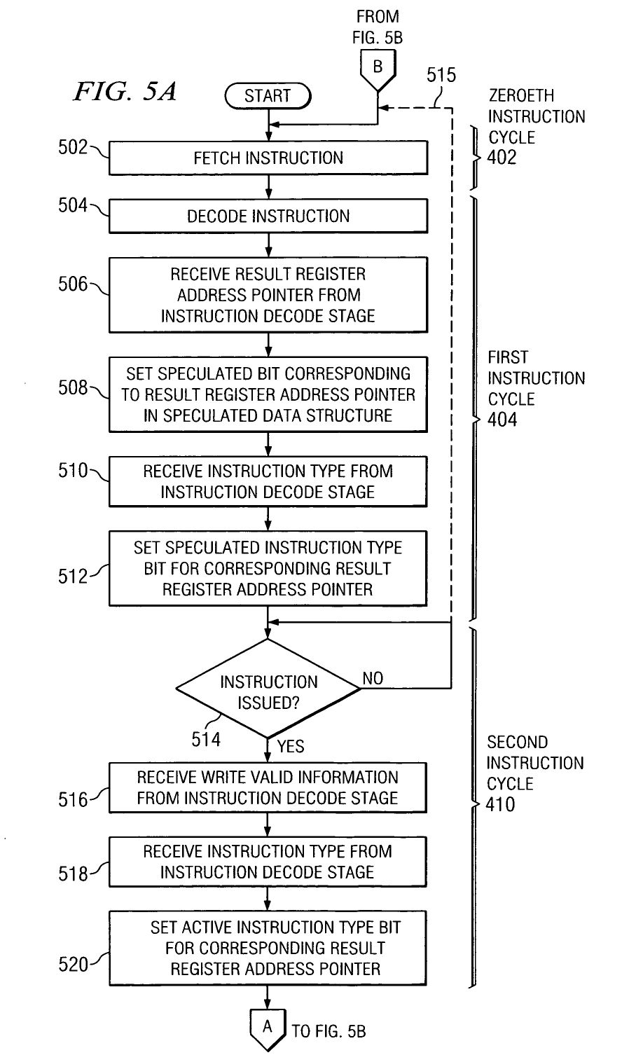

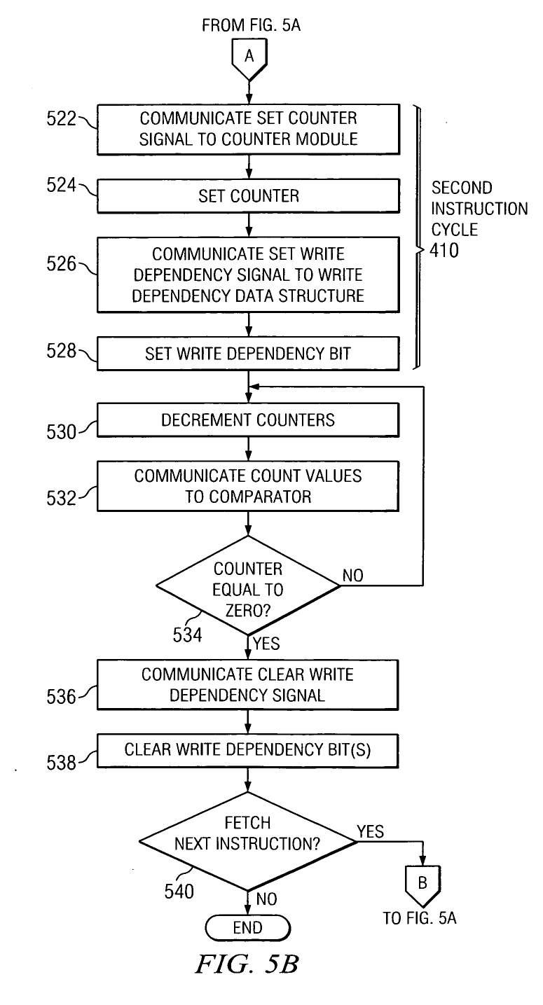

FIGS. 5A, 5B, and 6 illustrate flowcharts of example methods that may be used by the example secondary scoreboard 210 of FIGS. 2 and 3. Although the example secondary scoreboard 210 is described with reference to the flowcharts illustrated in FIGS. 5A, 5B, and 6, persons of ordinary skill in the art will readily appreciate that other methods of implementing the example secondary scoreboard 210 may additionally or alternatively be used. For example, the order of execution of the blocks depicted in the flowcharts of FIGS. 5A, 5B, and 6 may be changed, and/or some of the blocks described may be changed, eliminated, or combined.

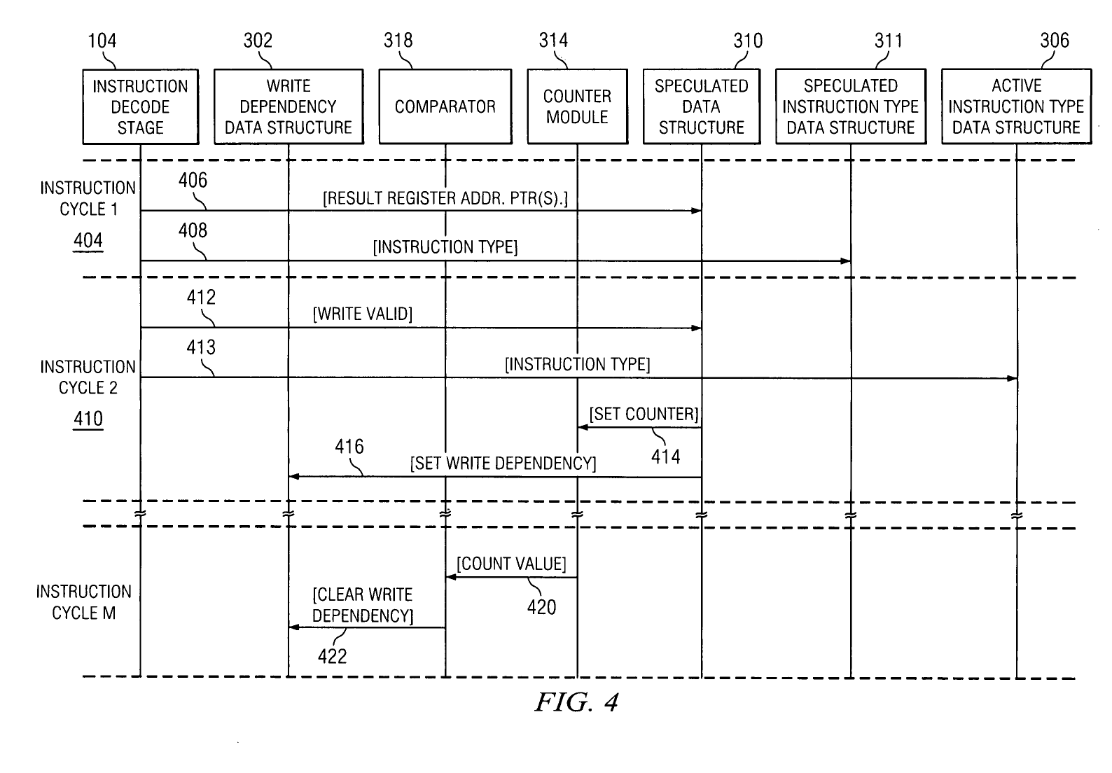

The flowchart of FIGS. 5A and 5B depicts an example method illustrating how information signals are communicated in the secondary scoreboard 210 to detect RAW data dependencies. The flowchart of FIGS. 5A and 5B is described in connection with the example secondary scoreboard 210 illustrated in FIG. 3 and an example instruction cycle diagram shown in FIG. 4. The example instruction cycle diagram of FIG. 4 illustrates example timing relationships between instruction cycles and the transmissions of signals in the example secondary scoreboard 210 of FIG. 3. During a zeroeth instruction cycle 402 (FIG. 5A), the instruction fetch stage 102 (FIG. 2) fetches an instruction from a memory (block 502). Although the example method of FIGS. 5A and 5B is described using one instruction, in alternative example implementations, the instruction fetch stage 102 may fetch two or more instructions substantially simultaneously.

During a first instruction cycle 404 (FIGS. 4 and 5A), the instruction decode stage 204 decodes the fetched instruction (block 504), and the speculated data structure 310 receives a register address pointer 406 (FIG. 4) from the instruction decode stage 204 (block 506). The result register address pointer 406 corresponds to one of the registers R_{N-1}-R₀ in the register file 110 (FIG. 2) to which the instruction in the instruction decode stage 204 will write a result value. In the illustrated example, one register address pointer (e.g., the result register address pointer 406) is provided by the instruction decode stage 204. However, in alternative example implementations, up to four register address pointers corresponding to four of the registers R_{N-1}-R₀ may be provided by the instruction decode stage 204 because the instruction decode stage 204 can decode and issue up to two instructions substantially simultaneously and each instruction can write up to two result values to the register file 110. In yet other alternative example implementations, the instruction decode stage 204 can decode and issue fewer or more instructions substantially simultaneously, the result register address pointers 404 may include fewer or more register address pointers corresponding to the registers R_{N-1}-R₀, and each of the instructions can write fewer or more result values to the register file 110.

The speculated data structure 310 then sets one of the speculated status bits [S_{N-1}, . . . , S₀] 312 (FIG. 3) corresponding to the received result register address pointer 406 (block 508). The speculated bit indicates that the instruction decode stage 204 may or may not have issued the instruction intended to write to the result register address pointer 406. For example, the instruction decode stage 204 may not issue the instruction if there is a data dependency in the primary scoreboard 210 (FIG. 1), a functional unit conflict, a memory conflict, or some other reason to not issue the instruction.

Also in the first instruction cycle 404, the speculated instruction type data structure 311 (FIGS. 3 and 4) receives the instruction type information 408 (FIG. 4) from the instruction decode stage 204 indicating the type of instruction fetched at block 502 (block 510). The instruction type information 408 is a logic signal (e.g., a bit value) indicating an integer instruction type or a floating-point instruction type. For example, a low logic signal may indicate an integer instruction type and a high logic signal may indicate a floating-point instruction type. The speculated instruction type data structure 311 then sets one of the speculated instruction type status bits [IS_{N-1}, . . . , IS₀] 313 (FIG. 3) corresponding to the result register address pointer 406 (block 512) to indicate the instruction type of the speculated instruction that will write a result in one of the registers R_{N-1}-R₀ corresponding to the result register address pointer 406.

During a second instruction cycle 410 (FIGS. 4 and 5A), if the instruction decode stage 204 has issued the instruction (block 514), then the speculated data structure 310 receives a write valid signal 412 from the instruction decode stage 204 (block 516) to indicate that the instruction has issued and that it will write a result value to one of the registers R_{N-1}-R₀ corresponding to the result register address pointer 406. However, if the instruction decode stage 204 does not issue the instruction in the second instruction cycle 410 (block 514), then the instruction decode stage 204 does not communicate the write valid signal 412 to the speculated data structure 310 in the second instruction cycle 410, but instead waits to communicate the write valid signal 412 during the instruction cycle in which it issues the instruction. If the issued instruction will not write a result value to one of the registers R_{N-1}-R₀ corresponding to the result address pointers 406 (e.g., the instruction is a branch instruction, a compare instruction, etc.), then the instruction decode stage 204 will not issue the write valid signal 412. In this case, control will be passed back to block 502 as indicated by phantom line 515 to fetch another instruction.

The active instruction type data structure 306 (FIGS. 3 and 4) receives the instruction type information 413 (FIG. 4) from the instruction decode stage 204 indicating the type of instruction fetched at block 502 (block 518). Alternatively, the active instruction type data structure 306 may receive the instruction type information 413 from the speculated instruction type data structure 311. The active instruction type data structure 306 then sets one of the active instruction type status bits [IA_{N-1}, . . . , IA₀] 308 (FIG. 3) corresponding to the result register address pointer 406 (block 520) to indicate the instruction type of the active instruction that will write a result in one of the registers R_{N-1}-R₀ corresponding to the result register address pointer 406.

Also in the second instruction cycle 410, in response to receiving the write valid signal 412, the speculated data structure 310 communicates a set counter signal 414 (FIG. 4) to the counter module 314 (FIGS. 3 and 4) (block 522) (FIG. 5B) and the counter module 314 sets one of the counters [C_{N-1}, . . . , C₀] 316 (FIG. 3) corresponding to the result register address pointer 406 (block 524). The counter module 314 sets the one of the counters [C_{N-1}, . . . , C₀] 316 with a value indicating the number of functional units (e.g., the execution stages 114a-c or the execution stages 116a-e of FIGS. 1 and 2) required by the execution stage 106 (FIGS. 1 and 2) to execute the type of instruction corresponding to the result register address pointer 406 addressing that register. For example, if a floating-point instruction requires five floating-point functional units, the counter module 314 sets a value of five in the one of the counters [C_{N-1}, . . . , C₀] 316 corresponding to the result register address pointers 406 affected by the instruction. The counter module 314 may obtain the instruction type information from the instruction type data structure 316 to determine the count value to store in the one of the counters [C_{N-1}, . . . , C₀] 316 corresponding to the result register address pointer 406.

In an example implementation in which the counter module 314 is implemented using shift registers [SR_{N-1}, . . . , SR₀], at block 524 the counter module 314 stores a bit in a shift register. In particular, the counter module 314 stores a bit at a bit position in the shift register indicative of the number of functional units (e.g., the execution stages 114a-c or the execution stages 116a-e of FIGS. 1 and 2) required by the execution stage 106 (FIGS. 1 and 2) to execute the type of instruction corresponding to the result register address pointer 406.

Also in the second instruction cycle 410, in response to receiving the write valid signal 412, the speculated data structure 310 communicates a set write dependency signal 416 (FIG. 4) to the write dependency data structure 302 (block 526) to indicate that the existence of a write dependency for the register R_{N-1}-R₀ corresponding to the result register address pointer 406 is definite because the instruction decode stage 106 has confirmed (via the write valid signal 412) that it has issued the instruction corresponding to the result register address pointers 406. The write dependency data structure 302 then sets one of the write dependency bits [W_{N-1}, . . . , W₀] 304 (FIG. 3) corresponding to the result register address pointer 406 (block 528).

During subsequent instruction cycles, the counter module 314 decrements the counter [C_{N-1}, . . . , C₀] 316 corresponding to the result register address pointer 406 (block 530) as the instruction passes through the execution stage 106. After each counter decrement or instruction cycle (block 530), the counter module 314 communicates a count value 420 to the comparator 318 (block 532) for the counter [C_{N-1}, . . . , C₀] 316 corresponding to the result register address pointer 406. The comparator 318 then determines whether the count value 420 is equal to zero (block 534). If the count value 420 corresponding to the result register address pointer 406 is not equal to zero (block 534), then in a subsequent instruction cycle, the counter module 314 decrements the counter [C_{N-1}, . . . , C₀] 316 corresponding to the result register address pointer 406 (block 530). However, if the count value 420 is equal to zero, the comparator 318 communicates a clear write dependency signal 422 (FIG. 4) to the write dependency data structure 302 (block 536) to indicate that the instruction has been executed by the execution stage 106 and the result corresponding to the result register address pointer 406 has been generated. The write dependency data structure 302 then clears one of the write dependency bits [W_{N-1}, . . . , W₀] 304 (FIG. 3) corresponding to the result register address pointer 406 (block 538). If the instruction decode stage 204 determines that it should fetch another instruction (block 540), then control is passed back to block 502 (FIG. 5A). Otherwise, the process of FIGS. 5A and 5B is ended.

FIG. 6 depicts a flowchart of an example method illustrating how the RAW data dependency information logic signal 324 (FIG. 3) may be retrieved from the secondary scoreboard 210 of FIGS. 2 and 3. In the illustrated examples described herein, each instruction may use up to four operands. Therefore, the secondary scoreboard 210 may receive up to four register address pointers corresponding to source operands to check the RAW data dependencies of the corresponding ones of the registers R_{N-1}-R₀. However, for purposes of clarity, the flowchart of FIG. 6 is described in connection with the secondary scoreboard 210 receiving one register address pointer corresponding to a source operand.

Initially, the active instruction type multiplexer 320a, the speculated write multiplexer 320b, the write dependency multiplexer 320c, and the speculated instruction type multiplexer 320d of FIG. 3 receive a source operand register address pointer (block 602) from the instruction decode stage 204 (FIGS. 2 and 3). The source operand register address pointer corresponds to one of the registers R_{N-1}-R₀ of the register file 110 (FIG. 2) that the instruction in the instruction decode stage 204 will use for a source operand value.

The write dependency multiplexer 320c then provides the AND gate 334 (FIG. 3) with one of the write dependency status bits [W_{N-1}, . . . , W₀] 304 (FIG. 3) from the write dependency data structure 302 (FIG. 3) corresponding to the source operand register address pointer (block 604). The speculated write multiplexer 320b then provides the AND gate 330 (FIG. 3) with one of the speculated status bits [S_{N-1}, . . . , S₀] 312 (FIG. 3) corresponding to the source operand register address pointer (block 606). The active instruction type multiplexer 320a then provides the exclusive-OR gate 326 (FIG. 3) with one of the active instruction type status bits [IA_{N-1}, . . . , IA₀] 308 (FIG. 3) from the active instruction type data structure 306 (FIG. 3) corresponding to the source operand register address pointer (block 608). In addition, the speculated instruction type multiplexer 320d provides the exclusive-OR gate 327 (FIG. 3) with one of the speculated instruction type status bits [IS_{N-1}, . . . , IS₀] 313 (FIG. 3) from the speculated instruction type data structure 311 (FIG. 3) corresponding to the source operand register address pointer (block 610). The exclusive-OR gates 326 and 327 then receive the instruction type of the pending instruction in the instruction decode stage 204 (block 612).

The AND gate 328 then receives an instruction conflict signal from the instruction decode stage 204 (block 614) indicative of any instruction conflicts (e.g., functional unit conflicts, memory conflicts, etc.) between the pending instruction and any active instruction in the execution stage 106 (FIG. 2). The AND gate 328 also receives a data dependency signal from the primary scoreboard 208 (FIGS. 2 and 3) (block 616) indicative of any data dependencies associated with the pending instruction in the instruction decode stage 204 detected by the primary scoreboard 208.

The AND gate 328 also receives the RAW dependency information logic signal 324 associated with a previous instruction cycle (block 618) and the secondary scoreboard 210 outputs the RAW dependency information logic signal 324 (block 620) for a current instruction cycle indicative of whether any RAW dependency exists for the source operand register address pointer received at block 602. In the illustrated example, if a RAW data dependency exists and the instruction types of the active instruction, the speculated instruction, and the pending instruction are the same (e.g., an intra-pipeline or intra-data-type data dependency exists) then the RAW dependency information logic signal 324 will output a logic signal indicating that a RAW dependency does not exist between different instruction types, thus allowing the instruction decode stage 204 to issue the pending instruction. In this case, even if the primary scoreboard 208 indicates that a data dependency exists between instructions of the same type, the instruction decode stage 204 will still issue the pending instruction once a respective one of the counters [C_{N-1}, . . . , C₀] 316 (FIG. 3) is equal to zero because the instruction will be able to obtain the result of the active instruction via a corresponding one of the forwarding paths 112a and 112b (FIG. 2). However, if the instruction types of the pending, active, and speculated instructions are different (e.g., an inter-pipeline or inter-data-type data dependency exists), then the instruction decode stage 204 will not issue the pending instruction until the active instruction and the speculated instruction are propagated through the pipeline 100 (FIG. 2) because the pending instruction would not be able to obtain the generated result of the active instruction via a forwarding path (e.g., one of the forwarding paths 112a or 112b). After block 620, the example method of FIG. 6 is then ended.

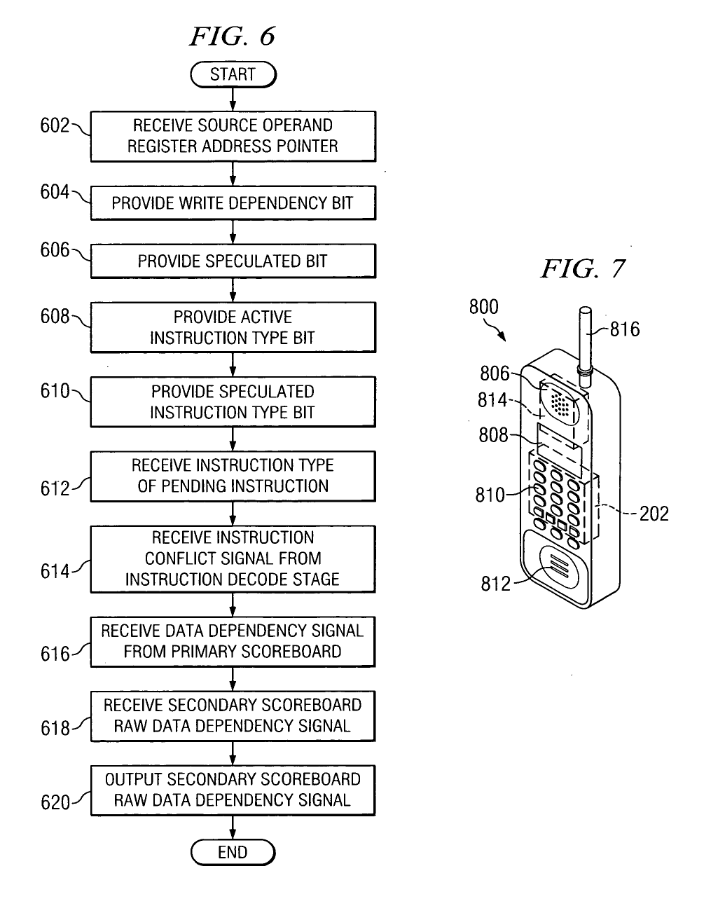

FIG. 7 illustrates an example wireless communication device 800 that may employ a processor including the example processor 202 of FIG. 2. The example wireless communication device 800 may be a mobile telephone (e.g., a cell phone, a wireless messaging device, etc.), a pager, a wireless game device, an MP3 player, etc. The example wireless communication device 800 includes a speaker 806, a display 808, a plurality of keys (e.g., buttons) 810, and a microphone 812, all of which may be communicatively coupled to the example processor 202.

The example wireless communication device 800 also includes a wireless communication transceiver 814 that is communicatively coupled to an antenna 816. The wireless communication transceiver 814 may be implemented using, for example, CDMA technology, TDMA technology, GSM technology, analog/AMPS technology, and/or any other suitable mobile communication technology. An example processor system incorporating the example processor 200 may be communicatively coupled to the wireless communication transceiver 814 and may use the wireless communication transceiver 814 to, for example, communicate with a wireless base station (not shown). The wireless communication device 800 may also include other electronics hardware such as, for example, a Bluetooth® transceiver and/or an 802.11 (i.e., Wi-Fi®) transceiver, both of which may be communicatively coupled to the example processor 202.

Although certain methods, systems, and articles of manufacture have been described herein, the scope of coverage of this patent is not limited thereto. To the contrary, this patent covers all methods, systems, and articles of manufacture fairly falling within the scope of the appended claims either literally or under the doctrine of equivalents.

1. A method comprising:
receiving an address pointer associated with a first instruction;
indicating a first data dependency status of the first instruction; and
indicating a second data dependency status of a second instruction based on an instruction type of the first instruction and an instruction type of the second instruction.

2. A method as defined in claim 1, wherein the address pointer is a register address pointer.

3. A method as defined in claim 1, further comprising determining the second data dependency status by comparing a first value indicative of the instruction type of the first instruction with a second value indicative of the instruction type of the second instruction.

4. A method as defined in claim 1, wherein the first data dependency status of the first instruction indicates a speculation that the first instruction has issued.

5. A method as defined in claim 1, wherein the second data dependency status indicates that the second instruction has issued.

6. A method as defined in claim 1, wherein indicating the first data dependency status comprises indicating via a first scoreboard the first data dependency status, and wherein indicating the second data dependency status comprises indicating via a second scoreboard the second data dependency status.

7. A method as defined in claim 1, further comprising:
storing a count value indicative of a quantity of execution stages in an instruction pipeline associated with completing execution of the second instruction; and
changing the second data dependency status based on the count value.

8. A method as defined in claim 7, wherein changing the second data dependency status indicates completion of a write operation associated with the second instruction.

9. A method as defined in claim 7, further comprising decrementing the count value during execution of the first instruction.

10. A method as defined in claim 7, wherein changing the second data dependency status comprises changing the second data dependency status when the count value is equal to zero.

11. A method as defined in claim 1, further comprising storing a bit in a shift register indicative of a quantity of execution stages in an instruction pipeline associated with completing execution of the first instruction, wherein a most significant bit of the shift register is indicative of the second data dependency status.

12. A method as defined in claim 1, wherein the instruction type of the first instruction is a floating-point data type, and wherein the instruction type of the second instruction is an integer data type.

13. A method as defined in claim 1, wherein the instruction types of the first instruction and the second instruction are selected from a group consisting of at least three instruction types.

14. An apparatus comprising:
an instruction pipeline having a first instruction type execution pipeline and a second instruction type execution pipeline;
a first scoreboard communicatively coupled to the instruction pipeline; and
a second scoreboard communicatively coupled to the instruction pipeline and the first scoreboard, the second scoreboard is configured to indicate a data dependency status of a first instruction based on an instruction type of the first instruction and an instruction type of a second instruction.

15. An apparatus as defined in claim 14, wherein the second scoreboard includes a data structure to store a value indicative of the instruction type of the first instruction.

16. An apparatus as defined in claim 14, wherein the second scoreboard includes a data structure to store a value indicative of a pending write operation associated with the first instruction, and wherein the second scoreboard is configured to indicate the data dependency status of the second instruction based on the value indicative of the pending write operation.

17. An apparatus as defined in claim 14, wherein the second scoreboard includes a counter to indicate a quantity of execution stages associated with completing execution of the second instruction, and wherein the second scoreboard is configured to indicate the data dependency status of the first instruction based on the quantity of execution stages.

18. An apparatus as defined in claim 17, wherein the counter is one of a shift register or a counter.

19. An apparatus as defined in claim 14, wherein the instruction type of the first instruction is an integer data type, and wherein the instruction type of the second instruction is a floating-point data type.

20. An apparatus as defined in claim 14, wherein there are no forwarding paths between the first instruction type execution pipeline and the second instruction type execution pipeline.

21. An apparatus as defined in claim 14, wherein the first instruction type execution pipeline is an integer execution pipeline, and wherein the second instruction type execution pipeline is a floating-point execution pipeline.

22. A processor comprising:
a first pipeline;
a second pipeline, wherein no data forwarding paths are implemented between the first and second pipelines;
a scoreboard to detect a data dependency and to enable issuance of a first instruction associated with the data dependency if the first instruction is of the same type as a second instruction associated with the data dependency.

23. A processor as defined in claim 22, wherein the scoreboard comprises a first scoreboard to detect the data dependency and a second scoreboard to enable the issuance of the first instruction.

24. The processor as defined in claim 22, wherein the first pipeline is an integer data type pipeline, and wherein the second pipeline is a floating-point data type pipeline.

25. The processor as defined in claim 22, wherein the scoreboard enables issuance of the first instruction by providing a logic signal to an instruction decode unit.

26. The processor as defined in claim 22, wherein the scoreboard stores a count value indicative of a quantity of execution stages in at least the first pipeline associated with completing execution of the second instruction.

27. The processor as defined in claim 26, wherein the scoreboard enables issuance of the first instruction based on the count value.

28. A mobile device comprising;
a housing;
an input device;
an output device;
a processor comprising:
an instruction pipeline having a first instruction type execution pipeline and a second instruction type execution pipeline;
a first scoreboard communicatively coupled to the instruction pipeline; and
a second scoreboard communicatively coupled to the instruction pipeline and the first scoreboard, the second scoreboard is configured to indicate a data dependency status of a first instruction based on an instruction type of the first instruction and an instruction type of a second instruction.

29. A mobile device as defined in claim 28, wherein the second scoreboard includes a data structure to store a value indicative of the instruction type of the first instruction.

30. A mobile device as defined in claim 28, wherein the second scoreboard includes a data structure to store a value indicative of a pending write operation associated with the first instruction, and wherein the second scoreboard is configured to indicate the data dependency status of the second instruction based on the value indicative of the pending write operation.

31. A mobile device as defined in claim 28, wherein the second scoreboard includes a counter to indicate a quantity of execution stages associated with completing execution of the first instruction, and wherein the second scoreboard is configured to indicate the data dependency status of the first instruction based on the quantity of execution stages.

32. A mobile device as defined in claim 31, wherein the counter is one of a shift register or a counter.

33. A mobile device as defined in claim 28, wherein the instruction type of the first instruction is an integer data type, and wherein the instruction type of the second instruction is a floating-point data type.

34. A mobile device as defined in claim 28, wherein there are no forwarding paths between the first instruction type execution pipeline and the second instruction type execution pipeline.

35. A mobile device as defined in claim 28, wherein the first instruction type execution pipeline is an integer execution pipeline and the second instruction type execution pipeline is a floating-point execution pipeline.
